SEQUENCE LISTING (1 sequence)

SEQ ID NO: 1 - DNA, 504 bp, Homo sapiens
cctccctcatctccagtgacgcctgcttgctgtaccaggcagtgtgaggagtgcagataagattcggtgcatctttcaacggaccctgagcaaagctaaagggctccgactcacgcacatagagggctgcccctcgtatcctgccctccttgagagcttgtgctaaggctttcttgtccaccaggccaccayggggtgcgttcacaaggaatgctccctgcctcatctgctttatggtaaagtcattgatgaggtggtggttatgttcgttgagattgcagtgcaaggagacgcagtcgctctgatacagcaaatcctacagagtgtagaccctctgcacgcccagggatcgctcgatcccatcctgcaagtaggggtcataaaatatgacgctgaatccaaaggccttggctcgaactgcaaccgcctgccccctgcgatcaaagccgatgaggcccagcatttccccacggatgctggccgatcccgaggccaactcgcggt

(19) United States
(12) Patent Application Publication
(10) Pub. No.: US 2006/0224328 A1
(43) Pub. Date: Oct. 5, 2006

(54) System and method for searching patents using DNA fragment number

(76) Inventor: Ki-eun Kim, Seoul (KR)

Correspondence Address: CANTOR COLBURN, LLP, 55 GRIFFIN ROAD SOUTH, BLOOMFIELD, CT, 06002, US

(21) Appl. No.: 11/264,730

(22) Filed: Nov. 1, 2005

(30) Foreign Application Priority Data
Mar. 31, 2005 (KR) 10-2005-0027026

(51) Int. Cl. G06F 19/00; G06F 17/30

(52) U.S. Cl. 702/20; 707/3; 705/3

(57) ABSTRACT

Provided is a system for searching for patent documents by using a DNA fragment number. The system includes a DNA fragment sequence database storing information about DNA fragment sequences; a patent sequence database storing information about patent DNA fragment sequences of patent documents; a patent database storing information about patent documents; an interface receiving a DNA fragment number from a client; a sequence extracting unit extracting a DNA fragment sequence corresponding to the DNA fragment number from the DNA fragment sequence database; a matching sequence search unit searching for patent DNA fragment sequences matching the extracted DNA fragment sequence in the patent sequence database; a patent number extracting unit searching for patent numbers of patent documents including the patent DNA fragment sequences from the patent sequence database; and a patent search unit searching for patent documents from the patent database by inputting the extracted patent numbers.

### BACKGROUND OF THE INVENTION

This application claims the priority of Korean Patent Application No. 10-2005-0027026, filed on Mar. 31, 2005 in the Korean Intellectual Property Office, the disclosure of which is incorporated herein in its entirety by reference.

1. Field of the Invention

The present invention relates to a system and method for searching patent documents using a DNA fragment number, and more particularly, to a system and method for searching patents related to a DNA fragment by inputting only a DNA fragment number and not a DNA fragment sequence.

2. Description of the Related Art

Human Genome Project has identified all of the nucleotide sequences of human genome. This is an epoch-making development in the diagnosis and treatment of incurable diseases caused by genes, opening an era of so-called personalized medicine and predictive medicine. When genes appropriately perform their given roles and functions, a human body develops normally and performs functions to sustain life. However, if a mutation occurs in even a minute part of a gene, various diseases and abnormalities, and in serious cases, even death, can occur. Genetics has been developed to reveal the functions of each gene and the relation between each gene and diseases. Accordingly, genetic diagnostics has been used in a clinical treatment.

Single Nucleotide Polymorphisms (SNPs) are also of great value to a biomedical research and in a clinical treatment. SNPs, which are single base-pair variations existing in DNA of individuals, make up most DNA sequence polymorphisms, and can occur in any region of a genome. SNPs occur in either a coding region or a noncoding region of a genome sequence. When SNPs occur in the coding region of the genome sequence, a defective or mutated protein can be expressed by one of the polymorphisms made by the SNPs. Some SNPs can cause a defective or mutated protein, as a result of a defective splicing, for example.

Some SNPs may not have any effect on a phenotype. SNPs occur once every 1,000 bp in humans. When a SNP affects the phenotype of, for example, a disease, a polynucleotide including the SNP, can be used as a primer or a probe in diagnosing the disease. A monoclonal antibody, which specifically binds to the SNP can also be used in diagnosing a disease. Currently, many research institutes have analyzed SNPs and their functions.

Nucleotide sequences of genes and SNPs determined through the Human Genome Project and other experiments have been compiled in a public database so that anybody can use the database. Unique numbers are assigned to the genes and SNPs, so that researchers over the world can easily find a gene or SNP sequence in the database using the unique numbers. The unique number of a gene can be, for example, X12345, and the unique number of a corresponding SNP can be, for example, rs12345.

Genes, which are determined as sequences and identified for their functions, can be protected with patents. For the fast and accurate examination of patent documents disclosing gene sequences, the World Intellectual Patent Office (WIPO), the United States Patent & Trademark Office (USPTO), the Japanese Patent Office (JPO), the Europe Patent Office (EPO), and the Korean Intellectual Property Office (KIPO) have tried to unify the way the gene sequences are disclosed in the patent documents.

However, in most cases, DNA sequence information from tens to hundreds of pages in length and unique numbers of genes or SNPs are not disclosed in patent documents. Therefore, it is impossible to conduct a patent search without knowing an accurate DNA sequence. In addition, even if a patent search is conducted using DNA sequences, search results are not accurate because the number of found patents is too big to check related sequences from the search results. Furthermore, even if a related sequence is found, it is difficult to check the exact location information in the case of SNPs.

Therefore, there exists a need for a system and method for effectively searching patent documents disclosing DNA fragments or the diseases related to the DNA fragments, using a unique number of the DNA fragment or the disease names as search terms, even if the DNA fragment, in particular, a SNP sequence, is unknown.

### SUMMARY OF THE INVENTION

The present invention provides a system for searching patent documents using a DNA fragment number.

The present invention also provides a method of searching patent documents using a DNA fragment number.

The present invention also provides a computer readable recording medium on which a computer program for performing a method of searching patent documents using a DNA fragment number is recorded.

According to an aspect of the present invention, a system for searching patent documents using a DNA fragment number includes a DNA fragment sequence database which stores information about DNA fragment sequences; a patent sequence database which stores information about patent DNA fragment sequences included in patent documents; a patent database which stores information about the patent documents; an interface which receives a DNA fragment number from at least one client as a first search term; a sequence extracting unit which extracts a DNA fragment sequence corresponding to the DNA fragment number from the DNA fragment sequence database in response to the DNA fragment number; a matching sequence search unit which searches for patent DNA fragment sequences having at least a portion matching the extracted DNA fragment sequence in the patent sequence database; a patent number extracting unit which searches for patent numbers of patent documents including the found patent DNA fragment sequences from the patent sequence database; and a patent search unit which searches for patent documents from the patent database in response to the extracted patent number.

According to another aspect of the present invention, a method of searching patent documents using a DNA fragment number includes: receiving a DNA fragment number as a first search term from at least one client; extracting a DNA fragment sequence corresponding to the DNA fragment number from a DNA fragment sequence database storing information about DNA fragment sequences in response to the DNA fragment number; searching for patent DNA fragment sequences having at least a portion matching the extracted DNA fragment sequence from a patent sequence database storing information about patent DNA fragment sequences included in patent documents; extracting patent numbers of patent documents including the patent DNA fragment sequences having at least the portion matching the found DNA fragment sequence from the patent sequence database; and searching for patent documents from a patent database storing information about patent documents in response to the extracted patent numbers.

According to further aspect of the present invention, a computer readable recording medium on which a computer program for performing the method of searching patent documents using a DNA fragment number is recorded is provided.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a system for searching patent documents using a DNA fragment number according to an embodiment of the present invention;

FIG. 2 is a flowchart illustrating a method of searching patent documents using a DNA fragment number according to an embodiment of the present invention;

FIG. 3 is an exemplary screen shot illustrating DNA fragment numbers;

FIG. 4 is an exemplary screen short illustrating DNA fragment sequences extracted by using a DNA fragment number;

FIG. 5 is another exemplary screen shot illustrating DNA fragment sequences extracted by using a DNA fragment number;

FIGS. 6A and 6B are exemplary screen shots, each showing a patent DNA fragment sequence; and

FIG. 7 is a view of a screen illustrating the results of patents searched by using a patent DNA fragment sequence.

### DETAILED DESCRIPTION OF THE INVENTION

The present invention will now be described more fully with reference to the accompanying drawings, in which exemplary embodiments of the invention are shown.

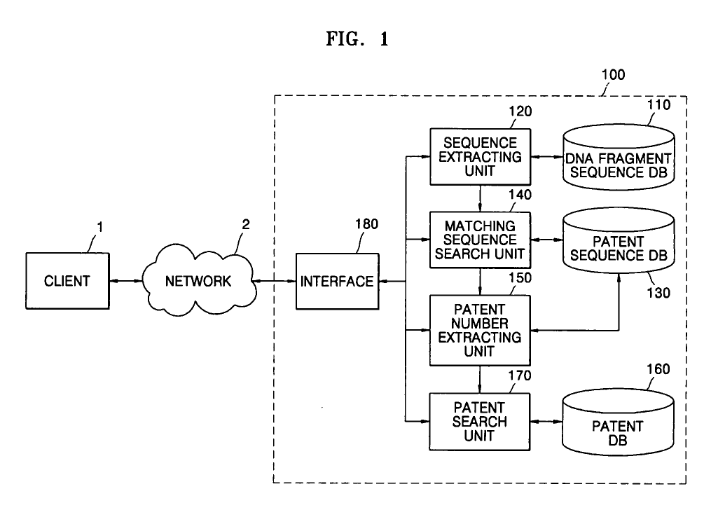

FIG. 1 is a block diagram of a system 100 for searching patent documents using a DNA fragment number according to an embodiment of the present invention. Referring to FIG. 1, the system 100 includes a DNA fragment sequence database 110, a patent sequence database 130, a patent database 160, an interface 180, a sequence extracting unit 120, a matching sequence search unit 140, a patent number extracting unit 150, and a patent search unit 170. At least one client 1 is connected to the system 100 via a network 2.

The DNA fragment sequence database 110 stores information about DNA fragment sequences. In an exemplary embodiment of the present invention, the DNA fragment includes any polynucleotide made up of nucleotides, for example, a SNP or a gene.

The information about the DNA fragment sequences include information about a DNA fragment number and DNA sequence, and may further include a registration date, the name of a register of the DNA fragment, related research results, a corresponding chromosome number, etc. If the DNA fragment is a SNP, the information about the DNA fragment sequence can further include a SNP location, a SNP sequence, and frequency of occurrence.

The DNA fragment sequence database 110 can include either a personal database or a professional database. The DNA fragment sequence database 110, for example, includes a database provided by the National Center for Biotechnology Information (NCBI), the Swiss Institute of Bioinformatics (SIB), or the European Bioinformatics Institute (EBI).

The patent sequence database 130 stores information about DNA fragment sequences disclosed in patent documents (hereinafter “patent DNA fragment sequence”). The information about the patent DNA fragment sequences includes DNA fragment sequences and related patent numbers.

The patent sequence database 130 can include either a personal database or a professional database. The patent sequence database 130, for example, includes a database provided by the NCBI, SIB, or EBI.

The patent database 160 stores information about patent documents such as patents and patent applications. The patent documents may include bibliographic data, a title of an invention, patent specifications, claims, drawings, and a sequence listing. The patent database 160 includes, for example, a database provided by the USPTO, the EPO, the JPO, or the KIPO. Also, the patent database 160 may be a database provided by a patent search company, for example, Delphion or Worldwide Intellectual Property Search (WIPS).

The interface 180 receives a DNA fragment number as a first search term from the client 1. The DNA fragment number is given by an institute such as the NCBI, SIB, or EBI and used to indicate a particular DNA fragment. The DNA fragment number is easily understood by those skilled in the related art to which the present pertains. For example, the DNA fragment number may be in the form of X12345, and, in the case of a corresponding SNP, may be in the form of rs12345.

The client 1 is connected to the interface 180 via the network 2. The interface 180 is connected to the sequence extracting unit 120, the matching sequence search unit 140, the patent number extracting unit 150, and the patent search unit 170.

The interface 180 may receive a second search term or search range from the client 1 via the network. The second search term may include a disease name. In an exemplary embodiment of the present invention, the interface 180 receives the DNA fragment number as the first search term from the at least one client 1 connected via the network 2 and transmits the DNA fragment number to the sequence extracting unit 120. In another exemplary embodiment of the present invention, the interface 180 may receive as the first and second search terms the DNA fragment number and a related disease name. A patent including a specific SNP and a specific disease name, for example, can be searched by using the specific SNP number or the specific disease name, as the search terms. Also, the second search term may be actual contents of a patent document, as well as bibliographic data such as the name of an applicant or inventor.

The search range may limit a scope of the searching to, for example, a title of an invention, abstract, claim, index, detailed description of the patent documents, or bibliographic data. In an exemplary embodiment of the present invention, patent documents in which a specific SNP sequence is disclosed in claims can be searched by limiting the search range to the claims of the patent documents. For example, when the interface 180 receives a SNP number and a specific disease name as the first and second search terms and claims as the search range, patent documents in which a corresponding SNP sequence and the specific disease name are disclosed in the claims are found.

The interface 180 transmits the first and second search terms or the search range to the patent search unit 170, and transmits the patent search result received from the patent search unit 170 to the client 1 via the network 2.

In addition to the patent search result, the interface 180 may also receive a sequence extracting result, a matching sequence search result, and a patent number extracting result respectively from the sequence extracting unit 120, the matching sequence search unit 140, and the patent number extracting unit 150, and transmit them to the client 1 via the network 2.

The sequence extracting unit 120 receives the DNA fragment number from the interface 180, extracts a DNA fragment sequence corresponding to the DNA fragment number from the DNA fragment sequence database 110, and transmits the DNA fragment sequence to the matching sequence search unit 140. The sequence extracting unit 120 may transmit the extracted DNA fragment sequence to the client 1 via the interface 180.

The matching sequence search unit 140 searches for a patent DNA fragment sequence including at least a portion matching the extracted DNA fragment sequence from the patent sequence database 130. If the extracted DNA fragment sequence is a SNP sequence, a patent DNA fragment sequence is searched for by considering both the SNP sequence and the SNP location. The matching sequence search unit 140 can be a commercial program such as a basic local alignment search tool (BLAST), FASTA, or a Smith-Waterman algorithm, and preferably BLAST. The matching sequence search unit 140 can transmit the found patent DNA sequence to the client 1 via the interface 180.

The patent number extracting unit 150 extracts patent numbers of patent documents in which the searched patent DNA fragment sequence is included. The patent number extracting unit 150 can transmit the extracted patent number to the client 1 via the interface 180.

The patent search unit 170 receives the extracted patent number from the patent number extracting unit 150, searches a patent document corresponding to the extracted patent number from the patent database 160, and transmits the results to the client 1 via the interface 180. The patent search unit 170 can receive the second search term or a search range via the interface 180. The second search term and the search range are the same as described above. The patent search results can include, for example, a patent application or registration number, a title of an invention, an abstract, claims, a DNA fragment number, a DNA fragment sequence, a corresponding sequence list, or a disease name. Also, the patent number or registration number, the DNA fragment number and so on listed on the patent search result page can be hyperlinked to relevant pages of the DNA fragment sequence database 110, the patent sequence database 130, and the patent database 160.

The system 100 according to an exemplary embodiment of the present invention includes, for example, a client-server type system. Thus, the operating program of the client 1 uses server information for easy communication between the client 1 and the server. For example, basic sever information such as a server IP address and a port number are inputted to the client 1. Although the system 100 in the present embodiment is described with a client-server environment, it is well known to those skilled in the related art to which the present invention pertains that the present invention can also be applied to a web or local environment.

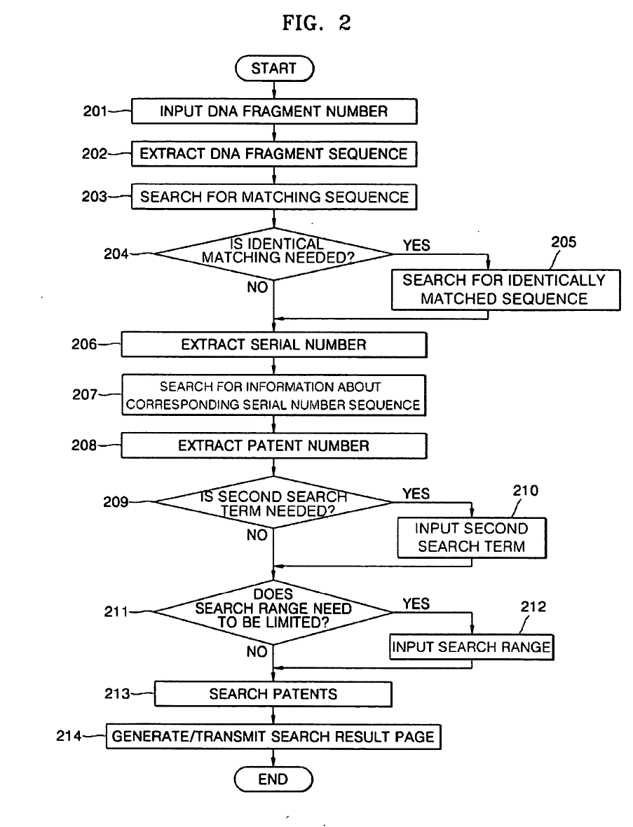

FIG. 2 is a flowchart illustrating a method of searching patent documents using a DNA fragment number according to an embodiment of the present invention. Referring to FIG. 2, the method includes receiving a DNA fragment number as a first search term from the client 1 (201); extracting a DNA fragment sequence corresponding to the DNA fragment number from the DNA fragment sequence database 110, which stores information about DNA fragment sequences, in response to the DNA fragment number (202); searching for a patent DNA fragment sequence including at least a portion matching the extracted DNA fragment sequence from the patent sequence database 130, which stores patent DNA fragment sequences listed in patent applications (203); extracting a patent number of a patent document including the patent DNA fragment sequence from the patent sequence database 130 (208); and searching for patent documents from the patent database 160, which stores information about the patent documents, in response to the extracted patent number (213).

In an exemplary embodiment of the present invention, the DNA fragment number is received from the client 1 (201) to the interface 180 via the network 2. The interface 180 transmits the DNA fragment number to the sequence extracting unit 120. The DNA fragment can be any type of fragment as long as it is a polynucleotide made up of nucleotides, and may be a SNP or a gene. One or more DNA fragment numbers can be received from the client 1.

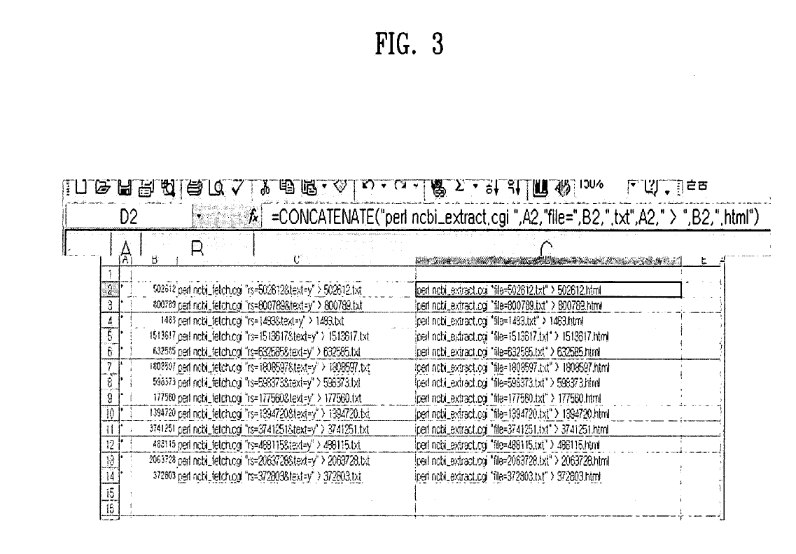

FIG. 3 is an exemplary screen shot illustrating the DNA fragment numbers received from the client 1 (201). Referring to FIG. 3, a plurality of SNP numbers, for example, rs50261, rs800789, rs1483, rs1513617, rs632585, rs1808597, rs598373, rs177560, rs1394720, rs3741251, rs488115, rs2063728, and rs372803, are input to the sequence extracting unit 120. In an exemplary embodiment of the present embodiment, Active State ActivePer15.6 is used as a basic program.

Then, the DNA fragment sequence corresponding to the DNA fragment number is extracted from the DNA fragment sequence database 110, which stores information about DNA fragment sequences, in response to the DNA fragment number (202). The DNA fragment sequence database 110 may be a database provided by NCBI, SIB, or EBI.

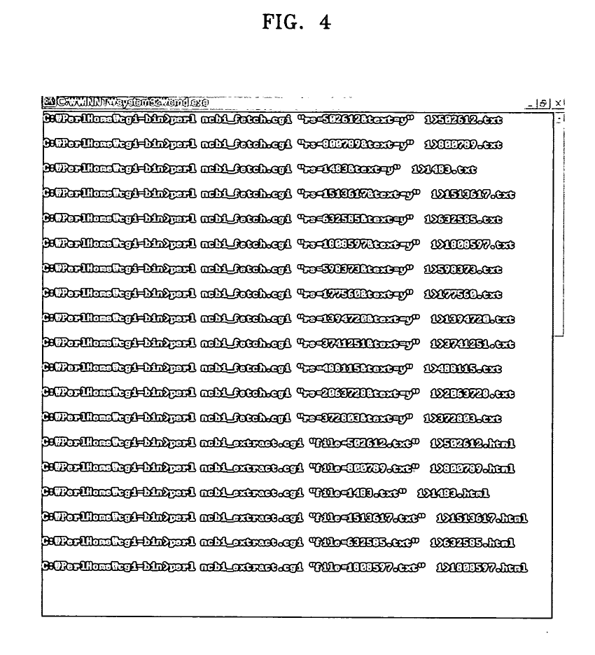

FIG. 4 is an exemplary screen shot illustrating the DNA fragment sequences extracted from the DNA fragment sequence database 110 (202). In FIG. 4, NCBI's SNP database is used as the DNA fragment sequence database 110.

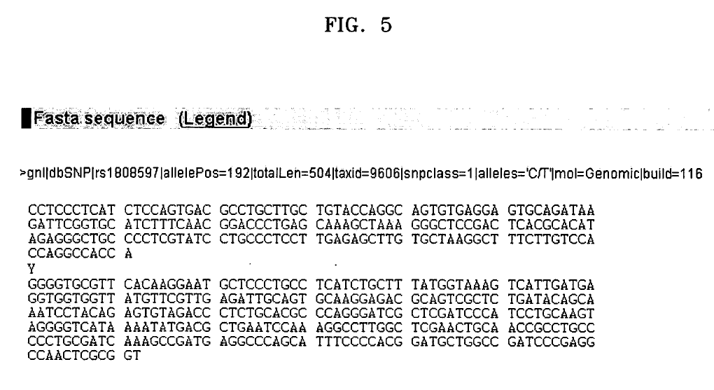

The extracted DNA fragment sequence (202) can be transmitted to either the client 1 via the interface 180 and the network 2 or the matching sequence search unit 140. FIG. 5 is another exemplary screen shot illustrating the DNA fragment sequences extracted from the DNA fragment sequence database 110 (202). In the exemplary embodiment of the present embodiment, rs1808597, which was a SNP number, was used as the DNA fragment number, and NCBI's SNP database was used as the DNA fragment sequence database 110.

Next, the patent DNA fragment sequence having at least a portion matching the extracted DNA fragment sequence is searched from the patent sequence database 130, which stores DNA sequences listed in patent documents (203). A database provided by NCBI, SIB, or EBI may be used as the patent sequence database 110. In addition, the matching sequence search (203) can be performed by a commercial program such as BLAST, FASTA, or Smith-Waterman algorithm, and preferably BLAST.

It is determined whether a patent DNA fragment sequence has to be identical to the extracted DNA fragment sequence (204). When the patent DNA fragment sequence has to be identical to the extracted DNA fragment sequence, an identical matching sequence search (205) is further performed. For example, the matching sequence search includes searching for the patent DNA fragment sequence including at least a portion matching the extracted DNA fragment sequence from the patent sequence database 130 (203) and searching for a patent DNA fragment sequence identical to the extracted DNA fragment sequence among the searched patent DNA fragment sequence (205).

When the DNA fragment according to the present invention is a SNP, the matching sequence search (203) must be performed considering both the SNP sequence and the SNP location.

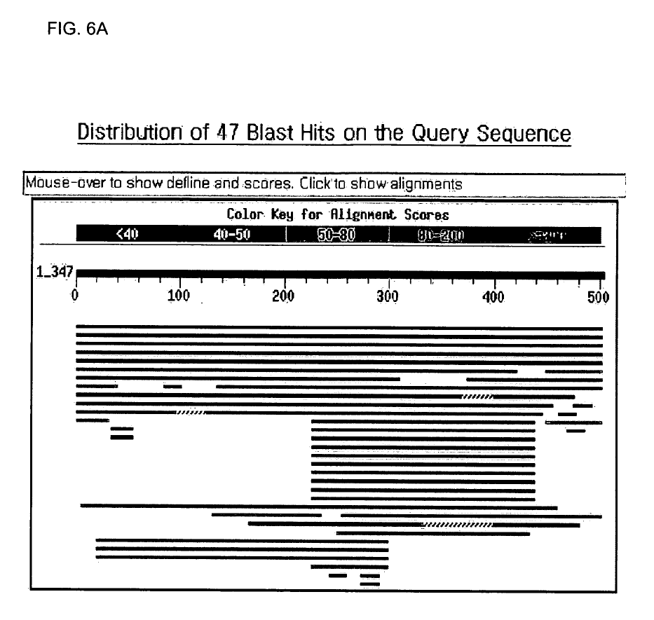

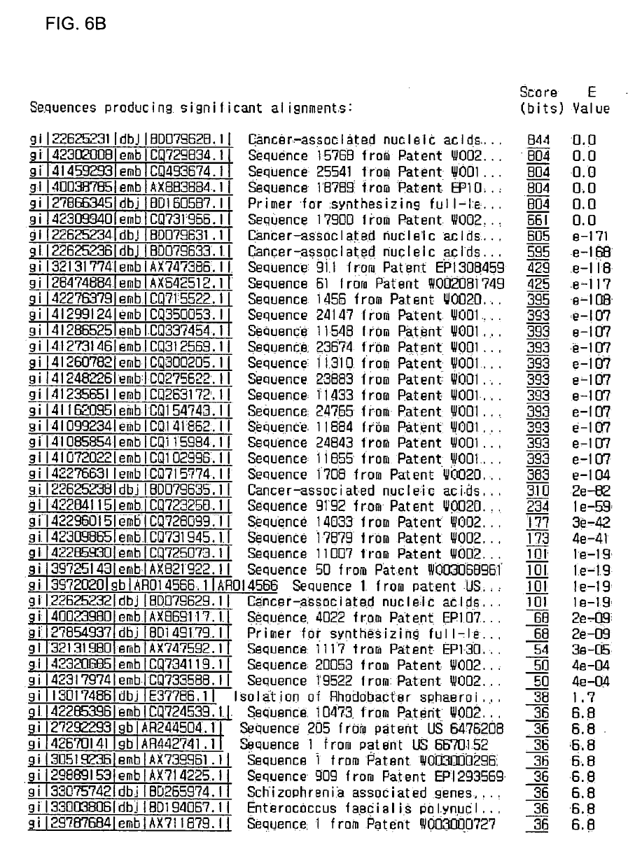

The results of the matching sequence search (203) can be transmitted to either the client 1 via the interface 180 and the network 2 orthe patent number extracting unit 150. FIGS. 6A and 6B are exemplary screen shots, each showing the search results for the matching sequence. In FIGS. 6A and 6B, BLAST was used as the matching sequence search unit 140, and the seventeen patent DNA fragment sequences including SNP location (# 192) were found from an original 47 search results.

Next, patent numbers of patent documents which include the patent DNA fragment sequence having at least a portion matching the extracted DNA fragment sequence are extracted from the patent sequence database 130 (208). The patent sequence database 130 is the same as described above.

In the patent number search (208), the patent number can be directly extracted from the patent sequence database 130. Alternatively, the patent number can be extracted from the patent sequence database 130 by extracting a serial number of the patent DNA fragment sequence (206), searching for information about a sequence corresponding to the serial number (207), and extracting a patent number from the patent sequence database 130 (208). The serial number of the patent DNA fragment sequence can be a registration number provided by institutes which provide each sequence database when the sequences are registered in the institutes. For example, gi numbers, which are registration numbers of sequences registered at the NCBI, can be used as the serial number.

The results of the patent number search (208) can be transmitted to either the client 1 via the interface 180 and the network 2 or the patent search unit 170.

Next, the patent documents are searched from the patent database 160, which stores information about patent documents, in response to the extracted patent number (213). The patent database 160 can be a database provided by the USPTO, EPO, JPO, or KIPO.

The patent search (213) can be performed by using the extracted patent number, but the second search term (210) or the search range (212) can be used. For example, it is determined whether the second search term is needed for patent search (209). If the second search term such as a disease name is required for patent search, the client (1) inputs the second search term (210), which is transmitted to the patent search unit 170 via the interface 180. If it is determined that the second search term is not required for patent search, it is then determined whether a search range is needed to limit the scope of the patent search (211). If the search range is required, the client (1) inputs the search range such as claims (212), which is transmitted to the patent search unit 170 via the interface 180.

The patent search results can include, for example, a patent application or registration number, a title of an invention, an abstract, claims, a DNA fragment number, a DNA fragment sequence, a corresponding sequence list, or a disease name. Also, the patent number or registration number, the DNA fragment number and so on listed on the patent search result page can be hyperlinked to relevant pages of the DNA fragment sequence database 110, the patent sequence database 130, and the patent database 160.

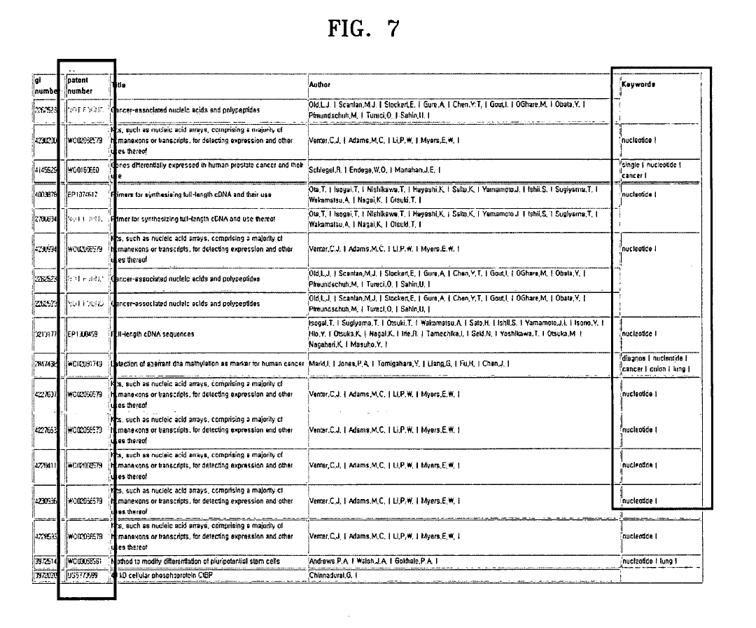

FIG. 7 is a screen shot illustrating the results of patents searched by using the DNA fragment sequences of FIG. 5. In FIG. 7, a patent database provided by the EPO was used as the patent database 160 and a second search term or a search range was not used.

The invention can also be embodied as a computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over the network coupled computer systems so that the computer readable code is stored and executed in a distributed fashion.

A test was conducted to search the patents related to rs7877, a SNP known to be related to myocardial infarction, by using a conventional patent search engine, for example, WIPS engine, and the system according to the present invention. No patent was found when rs7877 and SNP (or polymorphism) were used as first and second search terms in the conventional search engine, and 221 patents were found when any of cardiovascular, coronary, myocardial, and infarction and SNP (or polymorphism) were used as the first and second search terms in the conventional search engine. However, none of the 221 patents were related to the SNP rs7877 and myocardial infarction. When rs7877 was used as the first search term in the system according to the present invention, six patents were found, and when rs7877 and any of cardiovascular, coronary, myocardial, infarction were used as the first and second search terms in the system according to present invention, patent no. WO2004067774 related to SNP rs7877 and myocardial infarction was found.

Therefore, the system and method for searching patent documents according to the present invention can find the patent documents disclosing a DNA fragment sequence or diseases related to a DNA fragment sequence using an unique DNA fragment number or disease name, efficiently and easily, even when an unknown DNA fragment sequence, for example, a sequence of a SNP, is used as a search term.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A system for searching patent documents using a DNA fragment number, comprising:
a DNA fragment sequence database which stores information about DNA fragment sequences;
a patent sequence database which stores information about patent DNA fragment sequences included in patent documents;
a patent database which stores information about the patent documents;
an interface which receives a DNA fragment number from at least one client as a first search term;
a sequence extracting unit which extracts a DNA fragment sequence corresponding to the DNA fragment number from the DNA fragment sequence database in response to the DNA fragment number;
a matching sequence search unit which searches for patent DNA fragment sequences having at least a portion matching the extracted DNA fragment sequence in the patent sequence database;
a patent number extracting unit which searches for patent numbers of patent documents including the found patent DNA fragment sequences from the patent sequence database; and
a patent search unit which searches for patent documents from the patent database in response to the extracted patent numbers.

2. The system of claim 1, wherein the DNA fragment is a single nucleotide polymorphism (SNP) or a gene.

3. The system of claim 1, wherein at least one of the DNA fragment sequence database and the patent sequence database is provided by the National Center for Biotechnology Information (NCBI), the Swiss Institute of Bioinformatics (SIB), or the European Bioinformatics Institute (EBI).

4. The system of claim 1, wherein the patent database is provided by the United States Patent and Trademark Office (USPTO), the European Patent Office (EPO), the Japanese Patent Office (JPO), or the Korean Intellectual Property Office (KIPO).

5. The system of claim 1, wherein the interface receives from the at least one client a second search term or a search range.

6. The system of claim 5, wherein the interface is connected to the at least one client via a network.

7. The system of claim 6, wherein the interface receives the second search term or the search range from the at least one client connected via the network, transmits the second search term or the search range to the patent search unit, and transmits the patent documents searched from the patent search unit to the at least one client via the network.

8. The system of claim 5, wherein the second search term is a disease name.

9. The system of claim 5, wherein the search range is claims of patent documents.

10. The system of claim 1, wherein the matching sequence search unit is a Basic Local Alignment Search Tool (BLAST), FASTA, or a Smith-Waterman algorithm.

11. The system of claim 1, wherein the matching sequence search unit further searches for a patent DNA fragment sequence identical to the extracted DNA fragment sequence among the found patent DNA fragment sequences having the at least a portion matching the extracted DNA fragment sequence.

12. A method of searching patent documents using a DNA fragment number, the method comprising:
receiving a DNA fragment number as a first search term from at least one client;
extracting a DNA fragment sequence corresponding to the DNA fragment number from a DNA fragment sequence database storing information about DNA fragment sequences, in response to the DNA fragment number;
searching for patent DNA fragment sequences having at least a portion matching the extracted DNA fragment sequence from a patent sequence database storing information about patent DNA fragment sequences included in patent documents;
extracting patent numbers of patent documents including the patent DNA fragment sequences having at least the portion matching the found DNA fragment sequence from the patent sequence database; and
searching for patent documents from a patent database storing information about patent documents in response to the extracted patent numbers.

13. The method of claim 12, wherein the DNA fragment is a SNP or a gene.

14. The method of claim 12, wherein the DNA fragment sequence database is provided by the NCBI, SIB, or EBI.

15. The method of claim 12, wherein the patent database is provided by the USPTO, EPO, JPO, or KIPO.

16. The method of claim 12, wherein the searching for the patent DNA fragment sequences is performed by a BLAST, FASTA, or Smith-Waterman algorithm.

17. The method of claim 12, wherein the searching for the patent DNA sequences comprises:
determine whether a patent DNA fragment sequence identical to the extracted DNA fragment sequence is required; and
further searching for the patent DNA fragment sequence identical to the extracted DNA fragment sequence among the found patent DNA sequences when it is determined that the patent DNA fragment sequence identical to the extracted DNA fragment sequence is required.

18. The method of claim 12, wherein the DNA fragment is a SNP and;
wherein the searching for the patent DNA fragment sequences comprises searching for a patent DNA fragment sequence having the same SNP sequence and the same SNP location from the patent sequence database.

19. The method of claim 12, wherein the extracting of the patent numbers comprises:
extracting serial numbers of the found patent DNA fragment sequences;
searching for information about sequences corresponding to the serial numbers; and
extracting patent numbers based on the information.

20. The method of claim 12, further comprising:
receiving a second search term or a search range from the at least client via a network;
extracting the patent numbers of the patent documents including the patent DNA fragment sequences having at least the portion matching the found DNA fragment sequence from the patent database in response to the second search term or the search range.

21. The method of claim 20, wherein the second search term is a disease name.

22. The method of claim 20, wherein the search range is claims of patent documents.

23. A computer readable recording medium on which a computer program for performing the method of searching patent documents using a DNA fragment number according to claim 12 is recorded.
